(19) United States
(12) Patent Application Publication
(10) Pub. No.: US 2010/0308607 A1
(43) Pub. Date: Dec. 9, 2010

(54) Multi-impact absorber for a vehicle

(75) Inventor: Stephane GINJA, Amberieu en Bugey (FR)

Correspondence Address: OLIFF & BERRIDGE, PLC, P.O. BOX 320850, ALEXANDRIA, VA, 22320-4850, US

(73) Assignee: COMPAGNIE PLASTIC OMNIUM, Lyon (FR)

(21) Appl. No.: 12/796,286

(22) Filed: Jun. 8, 2010

(30) Foreign Application Priority Data
Jun. 8, 2009 (FR) 0953783

(51) Int. Cl. B60R 19/24

(52) U.S. Cl. 293/132

(57) ABSTRACT

The invention relates to an absorber comprising first and second portions and made at least in part out of plastics material, wherein the first portion includes a first support wall extending in a longitudinal direction of the absorber and placed to bear against a beam of the vehicle; the second portion includes a second support wall extending in a longitudinal dimension of the absorber and essentially perpendicularly to the first wall, being placed to bear against the beam; and the second portion includes reinforcing walls corresponding essentially to a plane normal to the longitudinal direction of the absorber and arranged so that each has one end connected to the second wall, each reinforcing wall having at least one other end connected to an adjacent reinforcing wall, such that each reinforcing wall is connected to each of the adjacent walls.

### FIELD OF THE INVENTION

The present invention relates to enabling a vehicle to handle impacts to which it is subjected.

### BACKGROUND OF THE INVENTION

Vehicle impact absorbers are known in the state of the art that are designed to be placed placing a front or rear impact beam of the vehicle that extends in the transverse direction of the vehicle, at the front of it when the beam is situated behind the front bumper skin of the vehicle. In this way, the absorber is interposed between the beam and the bumper skin. Such absorbers may also be placed on the rear beam of the vehicle.

An impact absorber is the subject of numerous impact requirements that are specific to particular countries or regions. Certain organizations, such as the Research Council for Automobile Repair (RCAR) provide for standardized absorption tests in order to determine the effectiveness of an absorber in the event of a so-called “insurance” impact. These tests seek to measure the cost of repairs in the event of impacts at low speed (less than 16 kilometers per hour (km/h)).

RCAR has found that when the absorber of a motor vehicle does not behave appropriately in the event of an impact between two motor vehicles, the (front or rear) impact beam of one of the vehicles generally passes over or under the (front or rear) impact beam of the other vehicle, thereby leading to severe damage to at least one of the two vehicles. Those tests have been performed in the past with a rigid barrier that simulates an obstacle. However, the excessively rigid nature of the barrier makes it difficult to take proper account of the damage caused by impacts between two vehicles or of the fact that the front or rear portions of two vehicles are deformable and give rise to higher levels of damage than during testing.

The Insurance Institute for Highway Safety (IIHS), a member of RCAR, has therefore recently established an absorption test using an obstacle that is deformable, e.g. a deformable barrier known as an “IIHS deformable barrier test” seeking to determine whether the assembly comprising the impact beam and the absorber of a vehicle enables damage to be avoided above or below the impact beam in the event of a low-speed impact (less than 16 km/h). Such an absorption test is referred to more particularly as a “RCAR bumper test”.

The absorption test serves in particular to verify:
whether the shape of the (front or rear) impact beam of the vehicle provides sufficient overlap with the (front or rear) impact beam of another vehicle with which it comes into collision;
whether the assembly comprising the impact beam and the absorber is sufficiently stable relative to the other vehicle in the event of an impact; and finally
whether the assembly comprising the impact beam and the absorber presents sufficient impact absorption properties to be capable, on its own, of absorbing the energy of an impact.

If these criteria are satisfied, the number of parts that need replacing on the motor vehicle after the impact is limited, ideally to no more than the bumper skin, the absorber, and the impact beam that has suffered the impact.

In order to simulate the front or rear portion of the other vehicle involved in the impact, the absorption test uses a simulation barrier that is designed to come into contact with the vehicle under test. That barrier has a rigid portion and a deformable portion for simulation purposes and it is positioned at a given height relative to the ground. The dimensions of such a barrier are standardized as a function of the standardized absorption test.

During a deformable barrier test, and when the height of the vehicle beam does not correspond to the height of the barrier, as applies to certain vehicles, then the barrier passes over or under the (front or rear) impact beam of the vehicle, thereby leading to severe damage to the vehicle.

This may apply in particular for vehicles in which the front or rear portion is lower than for conventional vehicles of the four-door sedan type, e.g. two-door vehicles, where the risk of damaging the hood and the headlight is increased compared with more conventional vehicles, and also for vehicles where the front is higher than that of conventional vehicles of the four-door sedan type, such as vehicles of the 4×4 type.

### OBJECT AND SUMMARY OF THE INVENTION

A particular object of the invention is to remedy that drawback by proposing an absorber that enables the vehicle to comply with the requirements of manufacturers for RCAR bumper test type impacts and also for pedestrian or urban type impacts without thereby increasing the costs of manufacturing the impact absorption system to any great extent.

For this purpose, the invention provides a vehicle impact absorber designed to be interposed between a bumper skin and a transverse vehicle beam so that the longitudinal direction of the absorber corresponds to the transverse direction of the vehicle, and the absorber comprising at least first and second absorption portions of distinct configurations that are superposed and secured to each other, the absorber being made at least in part out of plastics material, in which:
the first portion comprises at least a first support wall suitable for being placed to bear against a vertical wall of the vehicle beam when the absorber is mounted against the beam;
the second portion includes at least a second support wall extending essentially over the entire longitudinal dimension of the absorber and essentially perpendicularly to the first wall, suitable for being placed to bear against a horizontal wall of the beam when the absorber is mounted thereagainst;
the second portion includes a plurality of reinforcing walls corresponding essentially to a plane normal to the longitudinal direction of the absorber; and
the reinforcing walls are arranged in such a manner that each of them has a first end connected to the second wall, each reinforcing wall including at least one end and preferably two ends, distinct from the first end and connected to an adjacent reinforcing wall, such that each reinforcing wall is connected to each of the adjacent walls.

Such an absorber comprises two portions: the first portion for facing the beam to handle an impact such as a pedestrian impact or an urban impact, and the second portion designed to be located offset relative to the beam so as to co-operate with the first portion to handle an impact such as an impact against the barrier. The second portion may be placed above or below the beam depending on the configuration of the vehicle and on its height relative to the regulation height for the impact barrier. In general, it is arranged above the beam for a two-door type vehicle and below the beam for a 4×4 type vehicle. It should be observed that such an absorber may be placed at the front or at the rear of the vehicle.

The first and second portions may be shaped independently of each other concerning their shapes or their dimensions so as to be adapted to the particular types of shock that they are required to handle. The second portion may be shaped to be more rigid, preferably twice as rigid, than the first portion so as to mitigate the lack of a beam in register therewith. This rigidity is achieved in particular by the reinforcing walls, and the desired rigidity may be achieved by varying the distribution and the density of the reinforcing walls.

The orientation of the reinforcing walls of the second portion, normal to the longitudinal direction of the vehicle, and the fact that they are connected together, enables the second portion of the absorber to respond well once it is mounted on the vehicle, in the event of the vehicle impacting against the barrier. In addition, the fact that the second portion bears against the beam via the second support wall enables it to bear against the beam, thereby also achieving a better response for the vehicle in the event of an impact. The beam thus takes up some of the forces to which the second portion of the absorber is subjected in the event of an impact against a barrier.

As a result, because of the presence of the second portion, the impact beam does not pass over or under the barrier, which would give rise to significant damage to the vehicle.

Thus, such an absorber makes it possible to handle various types of impact, pedestrian impact, urban impact, and RCAR bumper test type impact, without making it complex to manufacture, with the variety of shapes and dimensions for the first and second portions being easily accommodated using known molding techniques.

This therefore enables the vehicle to respond well to impacts without greatly increasing the costs of manufacturing the impact absorption system. This is made possible without any need to modify the structure of the vehicle such as modifying the position of the beam relative to other elements of the vehicle, or to increase the height of the beam, which would also increase the weight and thus the manufacturing cost of the beam and would also obstruct at least in part the flow of air through the radiator.

The absorber of the invention may also include one or more of the characteristics in the following list:
the reinforcing walls are arranged in such a manner as to extend on either side of the first support wall. The fact that the reinforcing walls extend on either side of the first support wall means that they extend both in front of the beam, when the beam is a front beam (or behind the beam when the beam is a rear beam), and over the beam, thereby giving the second portion greater ability to withstand force by force being taken up by the top of the beam via the second portion (or by the bottom of the beam as the case may be);
the first and second portions are of configurations that are distinct, thereby enabling them to be better adapted to the specific features of each type of impact;
the second portion includes a third support wall that is essentially parallel to the first wall and that is not coplanar therewith, the support walls defining a housing for the beam. Thus, when the first support wall extends between the bodywork part and the beam, the third support wall extends between the beam and the vehicle cabin. It provides better engagement for the second portion against the beam and better takeup of forces by the beam. In addition, under such circumstances, the second portion of the absorber necessarily extends over the entire transverse dimension of the beam, thereby also making it possible to improve the handling of impacts;
the second portion comprises one or more of the elements in the following list:
   at least one hollow body;
   an array of ribs; and
   at least one wall forming alternating projections and depressions.
      Under such circumstances, the second portion may be shaped to form a checkerboard, i.e. alternating projections and depressions formed by a run of rectangular parallelepipeds each having two walls missing, with a rectangular parallelepiped missing the front and top walls being placed in alternation with parallelepipeds missing the rear and bottom walls. The second portion may also be shaped in such a manner that the front and rear free ends of the reinforcing walls, forming ribs projecting from the second support wall, are connected together by walls extending in the longitudinal direction of the absorber or in such a manner that the ends of the reinforcing walls opposite from the ends connected to the second support wall are also connected together by a wall that is essentially parallel to the second support wall. The second portion may also include additional ribs extending between the reinforcing walls;
the first portion may include one or more of the elements in the following list:
   an array of ribs, in particular undulating ribs;
   at least one hollow body; and
   at least one wall forming an alternation of projections and depressions.
      The first portion may comprise a C-shaped wall that is reinforced by preferably-vertical ribs, or it may be shaped as a checkerboard or it may include ribs extending essentially in the longitudinal direction of the absorber, projecting from the first support wall, which itself is plane. Any configuration for the first portion may be combined with any configuration for the second portion;
the absorber may include an additional portion extending above the first and second portions, when the absorber is mounted on the vehicle, and preferably including one or more of the elements in the following list:
   bumper skin reinforcement, also referred to as a “softnose”;
   an impact absorber suitable for a hip impact against a pedestrian;
   a support for an air inlet grille; and
   a hood closure abutment.
      When said portion is connected to the second portion of the absorber, it serves to increase the rigidity of the second portion since its top end is no longer free. In addition, the absorber forms a module having elements installed therein in conventional manner for mounting independently on the vehicle. These elements are thus mounted on a single occasion on the vehicle body so assembly time on the main assembly line is reduced, thereby enabling manufacturing costs to be reduced;
the absorber includes an additional portion situated beneath the first and second portions, comprising two uprights that are essentially perpendicular to the longitudinal direction of the absorber, preferably connected together at their ends opposite from the first portion by a bar that extends essentially in the longitudinal direction of the absorber, the bar constituting in particular a pedestrian impact absorber or a bearing point for handling an impact between the vehicle and a pedestrian's leg. In the same manner as above, such an absorber forms a module that enables vehicle assembly costs to be further reduced;
in its longitudinal direction, the absorber includes a central portion and two lateral portions, together with means for releasably fastening each lateral portion to the central portion. The two lateral portions of the absorber may be used for handling a corner impact, i.e. an impact at low speed against a corner of the vehicle, at an angle that is not zero relative to the longitudinal direction of the vehicle (for the standard US 581, 60° and 1.5 miles per hour (mph), i.e. 2.5 km/h), or indeed an impact test complying with the new corner impact defined by the RCAR bumper test, i.e. an impact of 5 km/h with 15% overlap between the barrier and the vehicle. The ability of a vehicle to handle such an impact is tested in certain countries only, e.g. the United States. The fact that the lateral portions of the absorber are separable thus enables absorbers shaped for a corner impact to be added only to those vehicles for which they are required. Such an absorber therefore enables corner impacts to be handled economically while guaranteeing easy management of absorber installation on different types of vehicle;
in the longitudinal direction of the absorber, the second portion extends over a fraction only of the dimension of the first portion. This may suffice to enable the vehicle to respond well to an impact while also serving to save on material used for fabricating the absorber, and as a result to further reduce the manufacturing costs of the absorber;
the first portion comprises a C-shaped wall arranged so that its concave side faces towards the beam when the absorber is mounted on the beam, with at least one end of said wall forming the first support wall;
the second portion is set back in a direction normal to the first support wall relative to the first portion when the absorber is mounted on the beam. In other words, when the absorber is mounted on the beam and it is observed from outside the vehicle (in front of the vehicle when the absorber is on the front beam of the vehicle), the second portion forms a setback relative to the remainder of the absorber; and
the absorber is made at least in part out of a thermoplastic material such as polypropylene (PP), polyethylene (PE), or polyamide (PA), or out of a thermosetting material, the material preferably being fiber-filled.

The invention also provides a vehicle impact absorber comprising at least first and second portions that are superposed and secured to each other, the absorber being made at least in part out of plastics material, wherein:
the first portion comprises at least a first support wall extending in a longitudinal direction of the absorber and suitable for being placed to bear against the beam of the vehicle when the absorber is mounted against the beam;
the second portion comprises at least a second support wall extending in the longitudinal direction of the absorber and essentially perpendicularly to the first wall, being suitable for being placed to bear against the beam when the absorber is mounted thereagainst;
the second portion includes a plurality of reinforcing walls corresponding essentially to a plane normal to the longitudinal direction of the absorber; and
the reinforcing walls are arranged in such a manner that each of them has a first end connected to the second wall, each reinforcing wall having at least one end, and preferably two ends, distinct from the first end and connected to an adjacent reinforcing wall, so that each reinforcing wall is connected to each of the adjacent walls.

The invention also provides an assembly of a vehicle beam and an absorber of the invention, the second portion being situated above or below the beam, the longitudinal direction of the absorber corresponding to the longitudinal direction of the beam, and the reinforcing walls extending in the transverse direction of the beam.

The assembly is designed to be interposed between a bumper skin and the structure of the vehicle.

In such an assembly, the second support wall preferably covers the top wall or the bottom wall of the beam over its entire transverse dimension, thereby enabling the beam to take up forces better.

The absorber optionally comprises a central portion and two lateral portions, the central portion having the same longitudinal dimension as the beam.

The term “lateral” portion is used to designate a part that is distinct from the central portion and that may optionally be fitted thereto, while it is naturally also possible for the absorber to comprise likewise a central portion having a certain configuration and end portions formed integrally with the central portion but presenting a configuration that is distinct from that of the central portion. Such end portions may be placed facing the beam, or otherwise.

The invention also provides a vehicle including such an assembly.

### BRIEF DESCRIPTION OF THE DRAWINGS

The invention can be better understood on reading the following description given purely by way of example and made with reference to the accompanying drawings, in which:

FIG. 1 is a perspective front view of an absorber according to a first embodiment of the invention;

FIG. 2 is a section view on A-A of the FIG. 1 absorber, when mounted on a vehicle beam;

FIG. 3 is a front perspective view of an absorber according to a second embodiment of the invention;

FIG. 4 is a section view on B-B of the FIG. 3 absorber, when mounted on a vehicle beam;

FIG. 5 is a front perspective view of an absorber according to a third embodiment of the invention;

FIG. 6 is a section view on C-C of the FIG. 5 absorber, when mounted on a vehicle beam;

FIG. 7 is a diagrammatic perspective view of an absorber according to another embodiment of the invention; and

FIG. 8 is a diagrammatic perspective view of an absorber according to yet another embodiment of the invention.

### MORE DETAILED DESCRIPTION

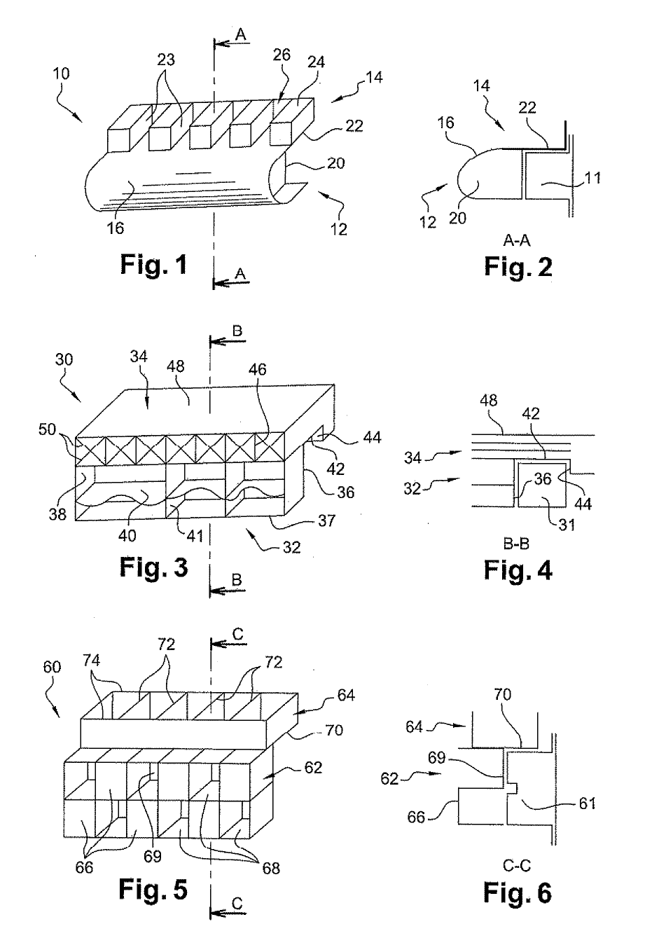

FIG. 1 shows an absorber 10 according to a first embodiment of the invention. The absorber is designed to be mounted on a vehicle front beam 11. The beam is made of a metal material and is configured using two section members, a channel section member and a flat member so as to form a hollow body, as can be seen more particularly in FIG. 2.

The absorber extends essentially in a longitudinal direction corresponding to the longitudinal direction of the beam 11 when it is mounted thereon, and corresponding likewise to the transverse direction of the vehicle.

The absorber 10 comprises first and second superposed portions 12 and 14, these two portions being of different configurations. The first portion 12 forms the bottom portion of the absorber and the second portion 14 forms its top portion.

As can be seen in FIG. 1, the first portion 12 comprises a C-shaped wall 16 with its concave side facing towards the vehicle beam 11 when the absorber is mounted thereon. Vertical ribs 20 extend essentially perpendicularly to the longitudinal direction of the absorber between the two branches of the wall 16 so as to unite the wall over the entire transverse dimension of its bottom branch.

As can be seen in FIG. 2, the bottom end of the wall 16 and the free ends of the ribs 20 are designed to bear against a front face of the beam 11 when the absorber is mounted on the vehicle beam, the beam itself being made up of two assembled-together section members, as can be seen in FIG. 2. The bottom end of the wall 16 and the free ends of the ribs form first support walls of the absorber on the beam 11.

The second portion 14 comprises a bottom wall 22 extending the top branch of the C-shaped wall 16. The absorber is shaped in such a manner that this wall bears against a top face of the beam 11 when the absorber is mounted on the beam. This wall 22 is essentially normal to the first support walls and constitutes a second support wall of the absorber on the beam. The second portion is shaped in such a manner that the wall covers the entire top face of the beam over the entire transverse dimension thereof.

The second portion also has vertical reinforcing walls 23 extending essentially perpendicularly to the longitudinal direction of the absorber. Each vertical reinforcing wall 23 has a bottom end connected to the second support wall 22.

The second portion is more particularly shaped so as to form a checkerboard. It comprises alternating projections 24 and depressions 26. To form the projections, two adjacent reinforcing walls 23 are connected together via their front ends and via their top ends. The bottom wall 22 includes a gap between the projection-forming walls 23, such that the projection 23 does not have a bottom wall. To form the depressions, two adjacent reinforcing walls are connected together via their rear ends and via the bottom wall 22.

In this embodiment, the second portion is set back relative to the first portion. In particular, the second portion is situated above the beam while the first portion is situated in front of it, and the two portions do not overlap in the transverse direction of the absorber.

There follows a description of an absorber according to a second embodiment of the invention, with reference to FIGS. 3 and 4.

This absorber 30 likewise comprises first and second superposed portions 32 and 34. It is also designed to be mounted on a vehicle beam 31 made up of a metal section member essentially in the shape of a rectangular parallelepiped.

The first portion 32 is shaped to present a U-shaped cross-section with its concave side facing outwards, and more particularly facing the bumper skin of the vehicle when the absorber is mounted on the vehicle. More particularly, the absorber comprises a web 36 between two flanges 37, respectively a top flange and a bottom flange that extend horizontally, projecting from the web towards the bumper skin of the vehicle and in the longitudinal direction of the absorber.

The web 36 is plane and vertical. It is arranged to extend in the longitudinal direction of the absorber. This web 36 forms a first support wall of the absorber on the beam 31. The flanges 37 are essentially perpendicular to the web 36.

The first portion also has vertical ribs 38 extending in the vertical direction and connecting together the top and bottom branches as well as the web 36 of the U-shape. It also has a horizontal rib 40 projecting from the web in the longitudinal direction of the absorber, essentially parallel to the flanges 37, which flanges have a linear free end in this example. The free end of this rib presents undulations.

The first portion also presents vertical ribs 41 connecting together the web 36, the two flanges 37, and the rib 40. The first portion is thus constituted by an array of ribs.

The second portion 34 comprises a bottom wall 42 coinciding with the top flange of the U-shape and extending in line therewith. The wall portion 42 extending the flange of the U-shape forms a second support wall of the absorber that is designed to be placed bearing against a top wall of the beam. The wall 42 covers the entire top surface of the beam.

The bottom wall 42 also presents a setback in its rear portion so that it has a downwardly-extending projection at the rear of the beam. As a result, at the setback, the wall 42 has a portion 44 that extends essentially parallel to the first support wall 36 and behind it. This portion 44 forms a third support wall of the absorber on the beam, bearing against the rear wall of the beam when the absorber is in place thereon. The walls 36, 42, and 44 define a housing for the beam 31.

The second portion also includes vertical ribs forming reinforcing walls 46 extending in the transverse direction of the absorber, projecting from the wall 42 along the entire length thereof, going from the free end of the top branch of the U-shape to the rear end thereof. These ribs 46 thus extend on both sides of the first support wall or web 36. They are also shaped so that their free ends form a horizontal straight line. The ribs thus vary in height in the vicinity of the setback 44 in the rear wall.

The second portion 34 also has a plane top wall 48 covering the free ends of the reinforcing walls so as to connect them together. It also has transverse ribs 50 extending between two ribs so as to connect the end connected to a given reinforcing wall to the free end of the adjacent reinforcing walls. These ribs 50 extend from the front end of the wall 42 as far as the setback thereof. They are inclined relative to the second support wall and to the reinforcing walls.

There follows a description of an absorber in a third embodiment of the invention, given with reference to FIGS. 5 and 6. Such an absorber is designed to be mounted on a beam 61 constituted by two metal section members, respectively a plane member and a W-shaped member, these two section members together forming a hollow body, as shown in FIG. 6.

The absorber 60 also has first and second superposed portions 62 and 64.

The first portion 62 is of checkerboard shape. More particularly, it comprises a wall constituted by alternating projections 66 and depressions 68, both in the longitudinal direction of the absorber and in the vertical direction thereof. The projections 66 and the depressions are more particularly disposed in a staggered configuration such that a given projection 66 lies between depressions, both in the longitudinal direction and in the vertical direction of the absorber.

Each depression 68 has a plane web 69 forming a first support wall for the absorber on the beam and arranged to bear against the front face of the beam when the absorber is mounted on the beam.

The second portion 64 of the absorber 60 has a bottom wall 70 coinciding in part with the top wall of the first portion 62 and extending rearwards in line therewith. The portion 70 of the wall situated in line with the first portion forms a second support wall of the absorber and it is arranged to bear against the top face of the beam. In this embodiment it does not cover the beam over its entire transverse dimension.

The second portion 64 also includes vertical ribs 72 extending in the transverse direction of the absorber, projecting from the wall 70. These ribs form reinforcing walls of the absorber. The front and rear ends of the reinforcing walls 72 are also connected together by vertical ribs 74 that also project from the wall 66 in the longitudinal direction of the absorber. The second portion is thus shaped as an array of ribs.

The rib 74 situated at the front of the reinforcing walls 72 extends forwards from the first support wall but is set back from the front of the first portion. The rib 74 situated at the rear of the reinforcing walls 72 extends to the rear end of the wall 66. The reinforcing walls 72 thus extend on either side of the first support wall 69, more particularly in front of and behind the support wall.

In all of the above-described absorbers, the first portion is designed to withstand a pedestrian impact and urban impacts, and the second portion is designed to withstand an impact against a barrier situated at a given height. It should be observed that the first portion will also be involved in the event of an impact against the barrier. The configuration and the thickness of the second portion enable it to be more rigid than the first portion of the absorber and to absorb the impact effectively in spite of the absence of the beam in register therewith.

Each of the absorbers is made of a thermoplastic material such as polypropylene and it is fiber-reinforced. The first and second portions are made by molding and the absorber may also include metal inserts, in particular positioned in the reinforcing walls of the second portion.

These absorbers are made by molding thermoplastic material, in particular injection molding, and as a result the first and second portions of the absorber are made integrally by molding.

There follows a description of an absorber in another embodiment of the invention.

Such an absorber 80 likewise comprises a first portion 82 suitable for being placed facing the impact beam of the motor vehicle, and possibly presenting one of the configurations described above, e.g. being configured as an array of ribs, as a C-shaped wall, or as a checkerboard.

The absorber also includes a second portion 84 extending above the first portion 82 and comprising a wall that projects rearwards relative to the first portion so as to be capable of bearing on the top face of the beam. The second portion 84 extends over a fraction of the longitudinal dimension of the first portion, and it is arranged in the central fraction of the first portion in the longitudinal direction thereof. It may also have one or other of the configurations as described above, e.g. as a checkerboard or as an array of ribs.

The second portion 84 is connected to a third portion 86 that extends above it and above the first portion, and that presents a trapezoidal shape with a short side corresponding to the top end of the second portion 84. This portion extends essentially vertically and it slopes rearwards a little at its top end in order to follow the outline of the vehicle.

This third portion 86 forms a strength member that reinforces the bumper skin suitable for carrying an absorber that enables an impact against a pedestrian's hip to be absorbed. The strength member 86 may also be shaped so that it itself performs this function of absorbing a hip impact against a pedestrian, given the material from which it is made and its configuration.

It also includes a support 88 for an air inlet grille, comprising an orifice of appropriate shape for receiving a grille and arranged at an appropriate height for receiving it, and it also has on a top end thereof an abutment 90 for closing the hood. This third portion may also have all of the functions conventionally present on a vehicle front panel.

The absorber also has a fourth portion 92 that constitutes a bottom portion thereof and that is secured to the first portion. This portion is thus situated below the first and second portions. This fourth portion comprises two uprights 94 extending vertically downwards when the absorber is mounted on the vehicle. These uprights are arranged at the ends of the first portion in the longitudinal direction thereof. They serve to absorb energy and improve vehicle-vehicle compatibility in the event of an impact.

The fourth portion also includes a bar 96 extending in the longitudinal direction of the absorber, parallel to the first portion. This bar is arranged at the free ends of the uprights 94. It may be arranged so as to be placed at the height of a pedestrian's knee and it is shaped so as to form a low level energy absorber for a pedestrian impact.

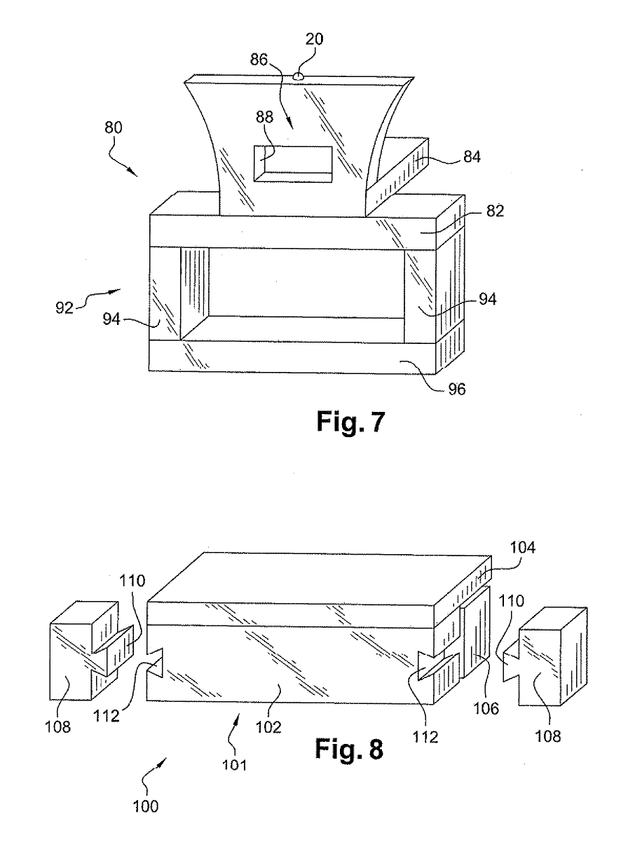

The uprights 94 and the bar 96, and also the strength member, may be shaped so as to form an array of ribs or a checkerboard so as to absorb the energy of an impact appropriately. The representation shown in FIG. 7 is not realistic and serves merely to show the outline of the absorber when it has the third and fourth portions 86 and 92.

Such an absorber is particularly advantageous since it forms a module presenting a plurality of functions suitable for being put into place on a vehicle body on a single occasion, thereby reducing manufacturing costs, and also repair costs after an impact.

FIG. 8 shows a variant of the absorber in an embodiment of the invention.

This absorber 100 has a central portion 101 comprising a first portion 102 and a second portion 104 that may be configured like the first and second portions shown in FIGS. 1 to 6. The central portion 101 essentially presents the same longitudinal dimension as the beam 106 on which it is placed.

The absorber also has two lateral portions 108 serving to extend the first portion 102 of the absorber in its longitudinal direction. These lateral portions 108 are suitable for being connected to the central portion of the absorber by co-operation between shapes, using snap-fastener elements of complementary shapes.

These lateral portions may have the same configuration as the central portion, or they may be of some other configuration. In particular, they may be configured as an array of ribs or as a checkerboard.

As can be seen more precisely in FIG. 8, each lateral portion 108 presents a projection 110 projecting from the absorber in a longitudinal direction thereof and extending in the transverse direction of the absorber on a lateral face of the lateral portion 108. This projection 110 is of trapezoidal section and the end that is connected to the remainder of the lateral portion corresponds to the short side of the trapezoid.

The first portion 102 of the central portion 101 also includes a depression 112 of shape complementary to the shape of the projection 110 in each of its lateral faces.

Co-operation between the projections 110 and the depressions 112 serves to secure the lateral portions 108 releasably to the central portion 101, thereby serving to extend the absorber, where necessary.

The lateral portions 108 of the absorber serve in particular to enable the vehicle to satisfy requirements in terms of a corner impact, i.e. an impact between the corner of the vehicle and a post. The response of the vehicle to such an impact is tested in certain countries only and it is therefore advantageous for the lateral portions to be removable so that vehicles for countries that perform the test are provided therewith, without it being necessary for all vehicles to be provided therewith.

It should be observed that the absorber is not restricted to the embodiments described above.

The absorber may be made of a material other than those described, for example a thermosetting material such as sheet molding compound (SMC). The absorber need not include metal reinforcements.

Furthermore, its shape is not restricted to the shapes described. For example, in addition to the first and second portions, the absorber may also include solely a third or a fourth portion. The shape of the third portion may also be different from that described. By way of example, it need not be as tall as the strength member described and it need not include a hood abutment. It may also extend over the entire length of the first portion, in particular when the second portion extends over the entire length of the first portion.

Similarly, the shape of the fourth portion is not restricted to that described above. It may include vertical uprights that do not extend from the ends of the first portion, for example.

Furthermore, the absorber need not bear entirely against the beam, particularly when the absorber presents lateral portions that do not bear against the beam. The absorber may be configured in such a manner as to be longer than the beam and it need not include lateral portions that are removable. Nevertheless, such an absorber is suitable for absorbing a corner impact lengthwise.

The absorber may also present a longitudinal dimension that is shorter than that of the beam.

When the absorber has lateral portions, they may also be of a height that is greater than the height of the first portion. They may also be assembled to the first portion by means other than those described, for example via projections and depressions of shapes other than those described or via screw-fastener means, for example. Such means may also be used in addition to fastener means operating by snap-fastening.

Furthermore, the configuration of each of the first and second portions may be different from that described, providing said portions are adapted to absorb the impacts for which they are designed. The first and second portions may also be identical in configuration.

Any of the configurations described for the first portion may be combined with any of the configurations described for the second portion.

The second portion may also be set back from the first portion, or not, regardless of the configuration of the first portion.

The two portions of the absorber may also include a plurality of hollow bodies. For example, the absorber may, for this purpose, have portions that are fitted on the support walls of the first and second portions.

In addition, the absorber as described may be put into place on a front beam or a rear beam of a vehicle.

It should also be observed that the first and second portions may be interchanged, depending on the nature of the vehicle, i.e. the second portion may be below the first portion. This is particularly appropriate for large vehicles of the sports utility vehicle (SUV) or 4×4 type, which have a beam at a height that is greater than that of the barrier used for the RCAR bumper type test.

It is also possible to envisage the beam and the absorber being made by molding, in particular for a rear beam.

What is claimed is:

1. A vehicle impact absorber designed to be interposed between a bumper skin and a transverse vehicle beam so that the longitudinal direction of the absorber corresponds to the transverse direction of the vehicle, wherein the absorber it comprises at least first and second absorption portions of distinct configurations that are superposed and secured to each other, the absorber being made at least in part out of plastics material, in which:
the first portion comprises at least a first support wall suitable for being placed to bear against a vertical wall of the vehicle beam when the absorber is mounted against the beam;
the second portion includes at least a second support wall extending essentially over the entire longitudinal dimension of the absorber and essentially perpendicularly to the first wall, suitable for being placed to bear against a horizontal wall of the beam when the absorber is mounted against the beam;
the second portion includes a plurality of reinforcing walls corresponding essentially to a plane normal to the longitudinal direction of the absorber; and
the reinforcing walls are arranged in such a manner that each of them has a first end connected to the second wall, each reinforcing wall including at least one end and preferably two ends, distinct from the first end and connected to an adjacent reinforcing wall, such that each reinforcing wall is connected to each of the adjacent walls.

2. An absorber according to claim 1, wherein the second portion includes a third support wall that is essentially parallel to the first wall and not coplanar with the first wall, the support walls defining a housing for the beam.

3. An absorber according to claim 1, wherein either or both of the first and second portions comprise(s) elements from the following list:
at least one hollow body;
an array of ribs, and
at least one wall forming alternating projections and depressions.

4. An absorber according to claim 1, including an additional portion situated above the first and second portions when the absorber is mounted against the beam, the additional portion forming a strength member preferably comprising one or more of the elements from the following list:
bumper skin reinforcement;
an impact absorber suitable for a hip impact against a pedestrian;
a support for an air inlet grille; and
a hood closure abutment.

5. An absorber according to claim 1, including an additional portion situated beneath the first and second portions when the absorber is mounted against the beam, the additional portion having two uprights essentially perpendicular to the longitudinal direction of the absorber, preferably connected together at their ends remote from the first portion by a bar extending essentially in the longitudinal direction of the absorber, the bar constituting in particular an impact absorber or a bearing surface for handling an impact against a pedestrian's leg.

6. An absorber according to claim 1, including, in its longitudinal direction, a central portion and two lateral portions, together with releasable fastener means for fastening each lateral portion to the central portion.

7. An absorber according to claim 1, wherein the second portion extends in the longitudinal direction of the absorber over a fraction only of the dimension of the first portion.

8. An absorber according to claim 1, made at least in part out of thermoplastic material such as polypropylene, polyethylene, or polyamide or out of a thermosetting material, and preferably fiber-filled.

9. An assembly of a vehicle beam and an absorber according to claim 1 for interposing between a bumper skin and the structure of a vehicle, wherein the second portion is situated above or below the beam, the longitudinal direction of the absorber corresponding to the longitudinal direction of the beam, the reinforcing walls extending in the transverse direction of the beam.

10. An assembly according to claim 9, wherein the second support wall covers the top or bottom wall of the beam over the entire transverse dimension of the beam.

11. A motor vehicle including an assembly according to claim 9.
